(19) United States
(12) Patent Application Publication
(10) Pub. No.: US 2026/0095507 A1
(43) Pub. Date: Apr. 2, 2026

(54) METHODS FOR AIOT OPERATION DURING UE READER MOBILITY

(71) Applicant: InterDigital Patent Holdings, Inc., Wilmington, DE (US)

(72) Inventors: Martino FREDA, Laval (CA); Erdem BALA, East Meadow, NY (US); Paul MARINIER, Brossard (CA); Brian MARTIN, Farnham (GB); Jongwoo HONG, New York, NY (US); Aata EL HAMSS, Laval (CA); Remun KOIRALA, London (GB)

(73) Assignee: InterDigital Patent Holdings, Inc., Wilmington, DE (US)

(21) Appl. No.: 18/902,013

(22) Filed: Sep. 30, 2024

(51) Int. Cl. H04L 67/12

(52) U.S. Cl. CPC H04L 67/12

(57) ABSTRACT

In some implementations, a method performed in a WTRU may include receiving, from a first network device, an event configuration for reporting a status of an AIoT inventory procedure in one or more AIoT devices and an AIoT inventory request. The method may include sending, to AIoT devices, a first message initiating an AIoT inventory procedure and detecting an event trigger. The method may include sending, to the first network device, a status report indicating a status of the AIoT inventory procedure ongoing in the AIoT devices. The method may include receiving, from the first network device, a mobility command corresponding to the event trigger, and transmitting, to the AIoT devices, a second message indicating an interruption of the AIoT inventory procedure currently ongoing in the AIoT devices and a third message containing an indication that the AIoT inventory procedure is being continued in the AIoT devices.

### BACKGROUND

In order to support the massive deployment of the Internet of Things (IoT) devices and advance the growth of the IoT market, future wireless technologies must be sustainable and energy efficient. Currently existing cellular IoT technology, relies on battery-powered devices. Ambient IoT may be viewed as a network of connected devices and sensors embedded in common everyday objects designed to gather and exchange data seamlessly in the background without the need of human interaction. It is an evolution of the Internet of Things (IoT) and emphasizes low-power, energy efficient devices that are always on.

The advancement of IoT technologies requires supporting battery-less or low-energy devices. Ambient IoT devices are expected to be battery-free, harvesting the energy from ambient sources such as electromagnetic, thermal, and solar. They will operate with limited energy storage capacity and will not require battery charging or replacement. 3GPP is currently studying this new class of IoT devices, termed as “Ambient IoT” (AIoT) devices, which will be integrated with cellular technology to meet the requirements mentioned above.

3GPP has agreed to a study item on AIoT in Rel19. Justification for this study item comes from the increased popularity of IoT. In recent years, IoT has attracted much attention in the wireless communication world. More ‘things’ are expected to be interconnected for improving productivity efficiency and increasing comforts of life. Further reduction of size, complexity, and power consumption of IoT devices can enable the deployment of tens or even hundreds of billion IoT devices for various applications and provide added value across the entire value chain. It is virtually impossible to power all the IoT devices by a battery or batteries that need to be replaced or recharged manually, leading to high maintenance cost, environmental issues, and even safety hazards for some use cases (e.g., wireless sensor in electric power and petroleum industry).

Considering the limited size and complexity required by practical applications for batteryless devices with no energy storage capability or devices with limited energy storage that do not need to be replaced or recharged manually, and considering the output power of an energy harvester that is typically from 1 μW to a few hundreds of μW, existing cellular devices may not work well with energy harvesting due to their peak power consumption of higher than 10 mW. Thus, the need exists for technological solutions to integrate AIoT devices with existing/future cellular or wireless networks.

### SUMMARY

In one general aspect, method may include receiving, from a first network device, an event configuration for reporting a status of an Ambient Internet of Things (AIoT) inventory procedure in one or more AIoT devices and receiving an AIoT inventory request for the one or more AIoT devices. The method may also include sending, to the one or more AIoT devices, a first message initiating an AIoT inventory procedure. The method may furthermore include detecting an event trigger, and may in addition include sending, to the first network device, a status report indicating a status of the AIoT inventory procedure currently ongoing in the one or more AIoT devices. The method may moreover include receiving, from the first network device, a mobility command corresponding to the event trigger. The method may also include transmitting, to the one or more AIoT devices, a second message indicating an interruption of the AIoT inventory procedure currently ongoing in the one or more AIoT devices. The method may furthermore include receiving, from the first or a second network device, an updated AIoT inventory request for the one or more AIoT devices. The method may in addition include transmitting, to the one or more AIoT devices, a third message containing at least an indication that the AIoT inventory procedure is being continued in the one or more AIoT devices. Other embodiments of this aspect include corresponding computer systems, apparatus, and computer programs recorded on one or more computer storage devices, each configured to perform the actions of the methods.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example inventory process for RFID;

FIG. 3A illustrates a topology with a base station (BS) to AIoT device;

FIG. 3B illustrates a topology with a BS to intermediate node to AIoT device;

FIG. 3C illustrates a topology with a BS to assisting node to AIoT device to BS with downlink assistance;

FIG. 3D illustrates a topology with a BS to assisting node to AIoT device to BS with uplink assistance;

FIG. 3E illustrates a topology with a WTRU to AIoT device;

FIG. 4 illustrates an example signal flow of an AIoT random access framework;

FIG. 5 is an example illustration of the required change of monitoring behavior which may occur at AIoT devices during a mobility operation at the reader;

FIG. 6 is an illustration of an example synchronization process according to an embodiment;

FIG. 7A illustrates an example case with connected mobility;

FIG. 7B illustrates an example case with idle/inactive mobility;

FIG. 7C illustrates an example case with RLF/Re-establishment mobility;

FIG. 7D illustrates an example case with an out of coverage mobility event;

FIG. 8 is a diagram illustrating different example cases of the timing of a mobility trigger during a random access;

FIG. 9 a signal flow diagram illustrating an example process of an intermediate WTRU experiencing a handover; and

FIG. 10 is a flow chart of an exemplary process according to one or more embodiments.

### DETAILED DESCRIPTION

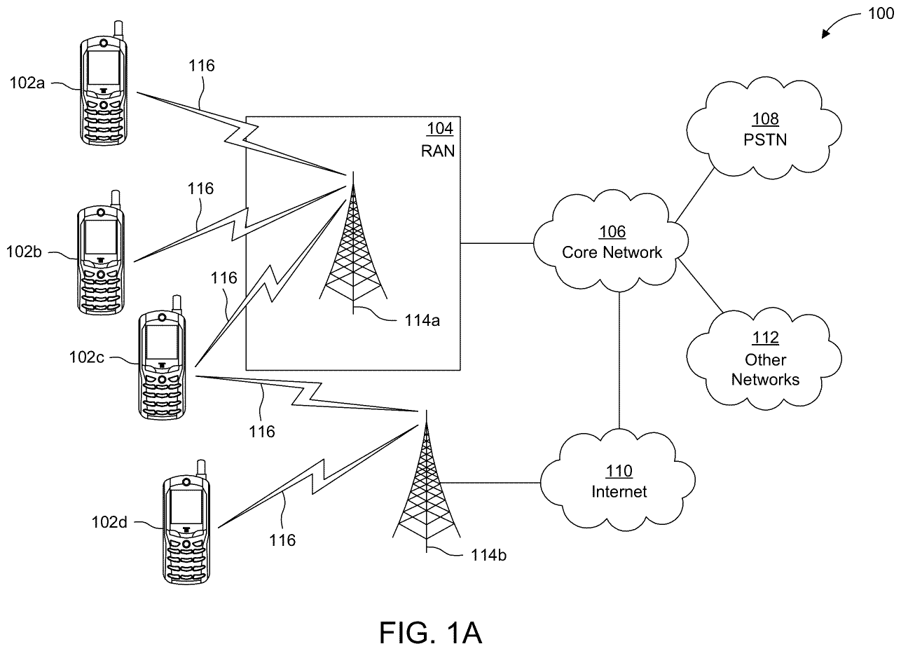

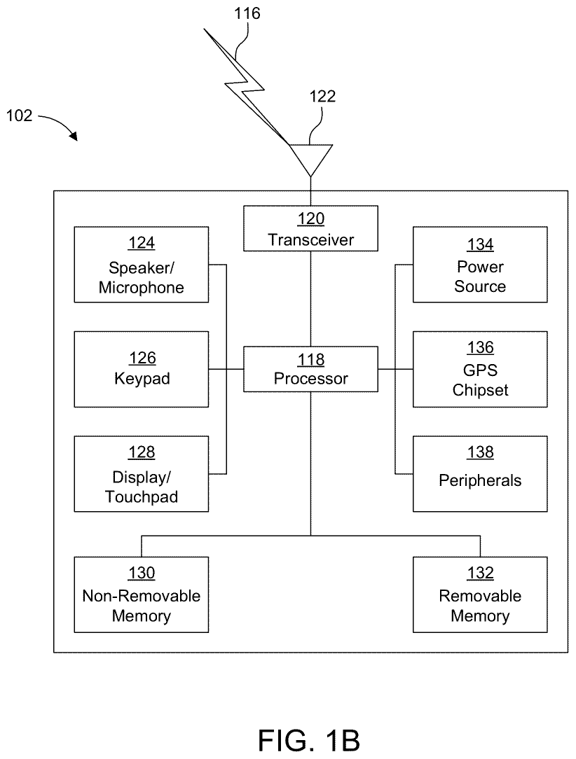

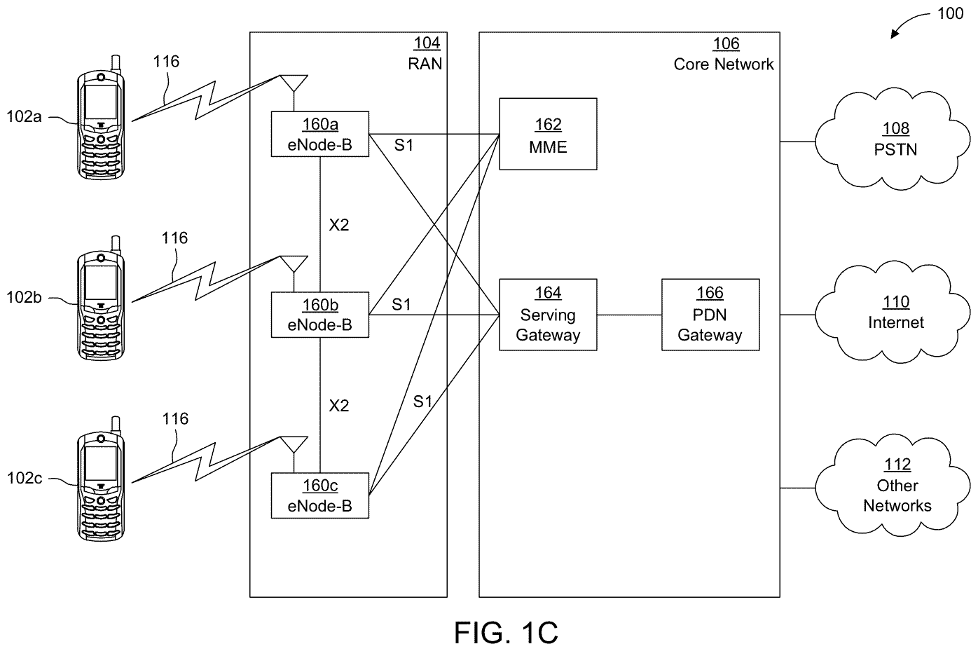

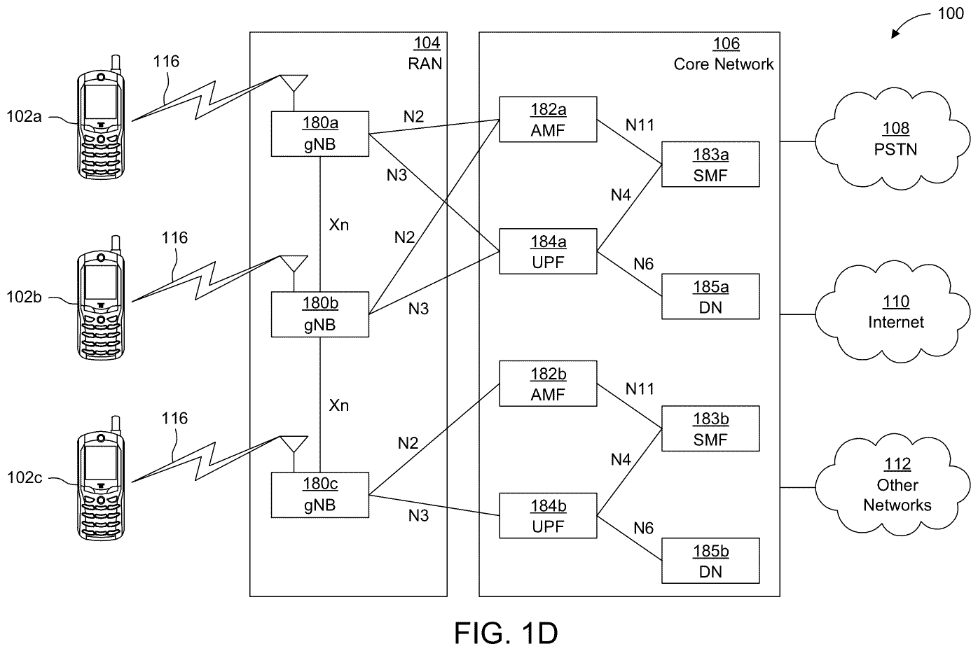

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc”mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

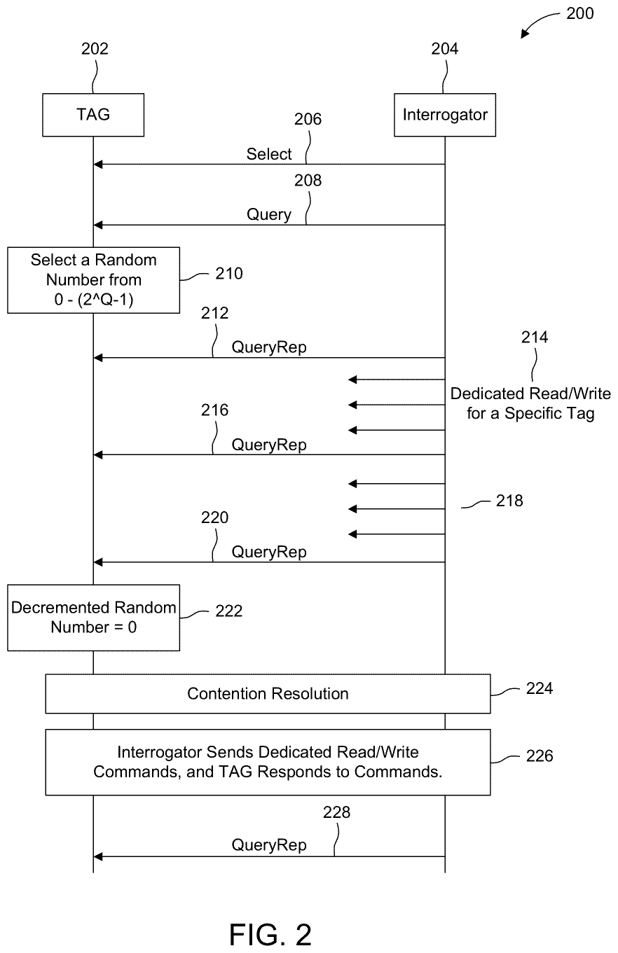

FIG. 2 illustrates an example inventory procedure for RFID. RFID is currently used for applications of asset identification.

In the inventory procedure 200, an interrogator sends a Query message to energize all or a subset of TAGs. Interrogator 204 selects TAG 202 at 206 and sends a query at 208 to energize TAG 202. At 210, TAG 202, in response to the query at 208, selects a random number from 0-2\hat{ }Q-1 and loads its memory with that number at 210. At each transmission of QueryRep, 212, 216, and 220, TAG 202 decrements its counter until the counter reaches 0. For example, after transmitting QueryRep 212, integrator 204 may transmit dedicated read/write commands 214, and after transmitting QueryRep 216, integrator 204 may transmit dedicated read/write commands 218. At 222, when the counter reaches 0, TAG 202 initiates contention resolution procedure 224 which consists of transmitting its device ID in the uplink, and waiting for confirmation of the device ID in the downlink (to address possible collision between multiple devices selecting the same random number). When TAG 202 has passed contention resolution, interrogator 204 may send multiple read/write commands to TAG 202, to which TAG 202 should respond. Interrogator 204 may transmit QueryRep, 228 followed by read/write commands.

Several AIoT topologies related to 3GPP cellular or wireless systems are considered. Example AIoT topologies related to 3GPP cellular/wireless systems are illustrated.

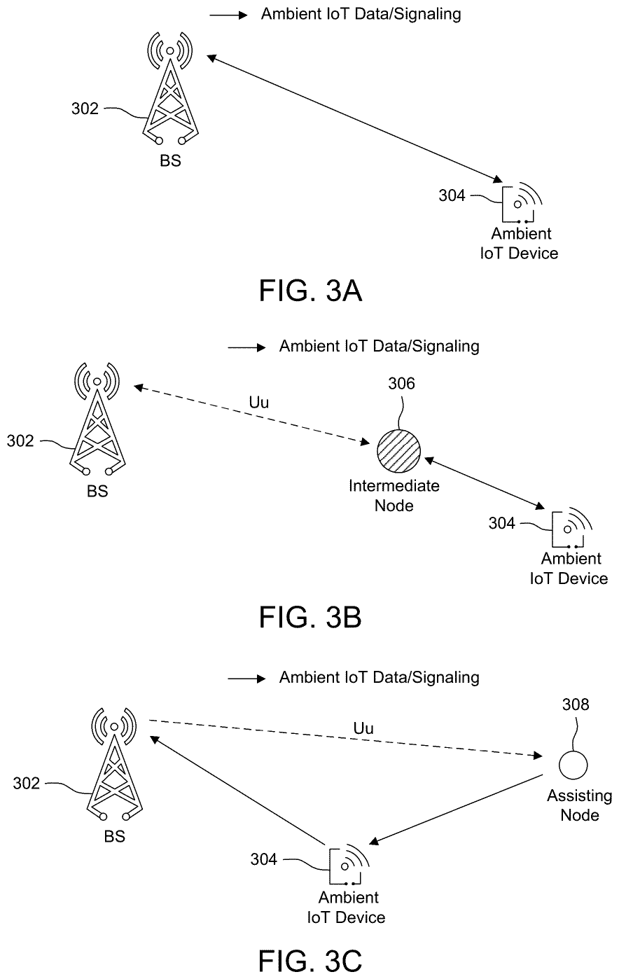

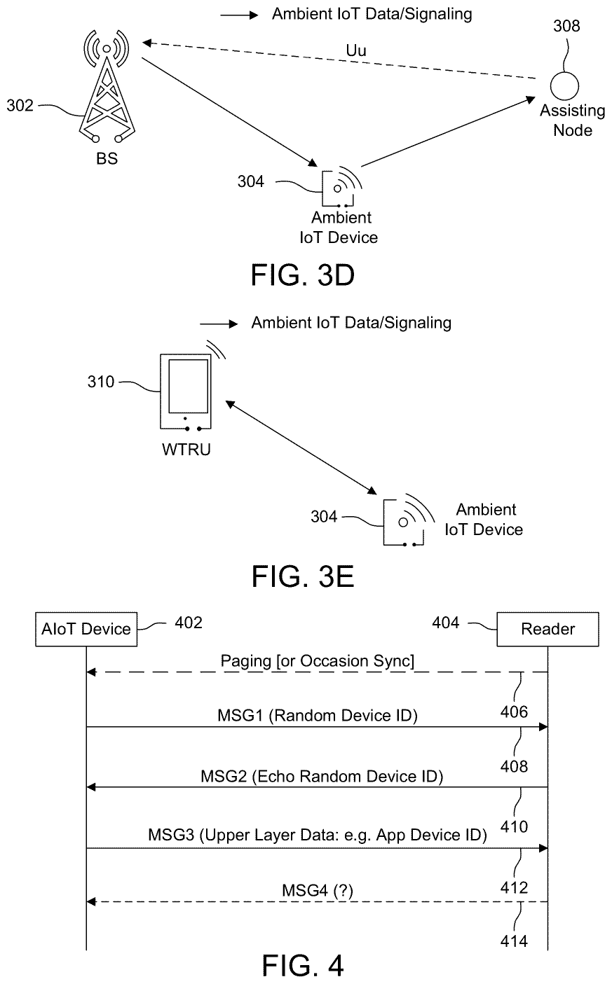

FIG. 3A illustrates a topology with a base station (BS) to AIoT device. In this topology, AIoT device 304 communicates with BS 302 directly and bidirectionally. The communication between BS 302 and AIoT device 304 includes Ambient IoT data and/or signaling. This topology includes the possibility that the BS transmitting data to the AIoT device is a different BS from the BS receiving data from the AIoT device.

FIG. 3B illustrates a topology with a BS to intermediate node to AIoT device. In this topology, AIoT device 304 communicates bidirectionally with an intermediate node 306 between AIoT device 304 and BS 302. In this topology, intermediate node 306 may be a relay, an Integrated Access Backhaul (IAB) node, a UE/WTRU, a repeater, etc. which is AIoT capable. The intermediate node transfers the information between BS and the AIoT device.

FIG. 3C illustrates a topology with a BS to assisting node to AIoT device to BS with downlink assistance. In this topology AIoT device 304 transmits data/signaling to BS 302, and receives data/signaling from assisting node 308. In this topology, assisting node 308 may be a relay, IAB, UE/WTRU, repeater, etc. which is AIoT capable.

FIG. 3D illustrates a topology with a BS to assisting node to AIoT device to BS with uplink assistance. In this topology AIoT device 304 receives data/signaling from BS 302 and transmits data/signaling to assisting node 308. In this topology, assisting node 308 can be a relay, IAB, UE/WTRU, repeater, etc. which is AIoT capable.

FIG. 3E illustrates a topology with a WTRU to AIoT device. In this topology AIoT device 304 communicates with WTRU 310 bidirectionally. The communication between WTRU and the AIoT device includes Ambient IoT data and/or signaling.

FIG. 4 illustrates an example signal flow of an AIoT random access framework.

Reader 404 sends a paging message 406 and a set of occasion synchronization messages which provides the device ID of AIoT device 402 and configures/delimits the random access occasions for transmissions by AIoT device 402. At 408, AIoT device 402 selects an occasion (using at least slotted ALOHA as the baseline), and transmits a random device ID in MSG1. Reader 404, upon successful reception of MSG1, transmits MSG2 at 410 by including the received random device ID in MSG2. If AIoT device 402 receives the echoed random device ID in MSG2, at 412 it transmits MSG3 which contains upper layer data (e.g., an application layer device ID). At 414, MSG4 may be sent by reader 404 (e.g., for subsequent command transmission), but the understanding is that contention is already resolved at MSG2 transmission.

With reference to topology illustrated in FIG. 3B, a random access can be triggered by a WTRU reader which is capable of AIoT reader operations, and which is in the control/coverage of a cell which supports reader configuration. Such a reader WTRU may perform mobility operations (e.g., HO, cell re-selection) and may experience mobility failures (e.g., RLF, re-establishment, etc.).

In this topology, AIoT resources used by the WTRU reader and provided to the AIoT device for device transmission are to be allocated/managed by the cell/gNB. Since such resources are allocated from Uu resources of the cell, each cell/gNB may manage its AIoT resources independently to maintain radio resource efficiency. This may lead to a different resource configuration/usage allowable by the WTRU reader when it moves from one cell to another. If a mobility event is triggered during an ongoing inventory procedure, management of the resources during and/after the inventory procedure should be such that it avoids interference to other Uu WTRUs by the AIoT reader and/or device transmissions.

In addition, to avoid unnecessary power consumption at the AIoT devices and inefficient resource usage, it should be possible to seamlessly continue an AIoT operation with minimal impact on the device. For example, long periods of monitoring by the device (in the case of mobility failure) or unnecessarily re-inventorying of the AIoT device should be avoided. The mobility procedure should also consider the unavailability of a AIoT device due to energy harvesting.

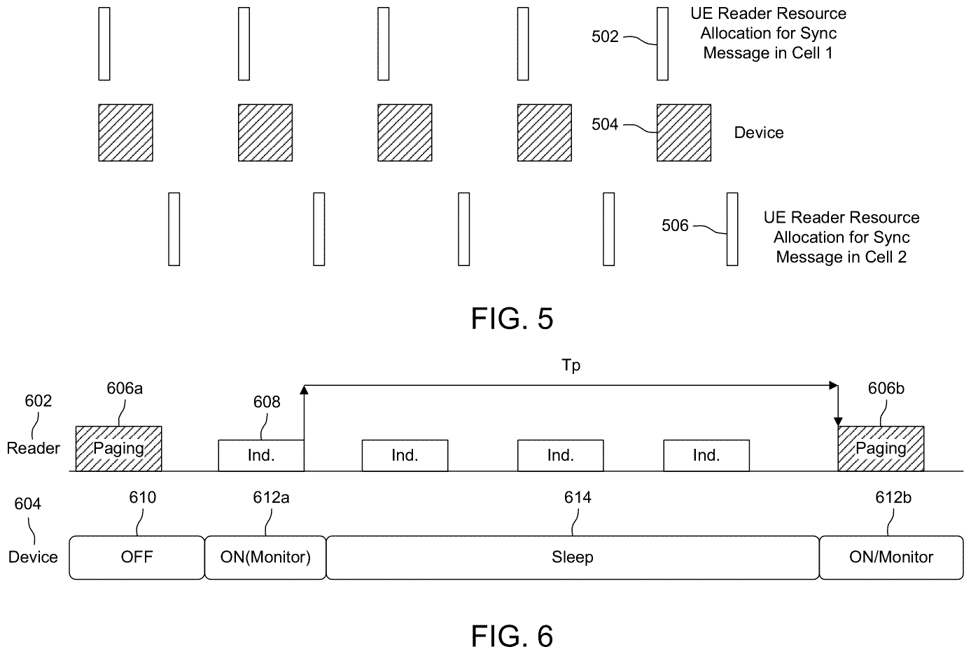

FIG. 5 illustrates an example of the required change of monitoring behavior which may occur at AIoT devices during a mobility operation at the reader.

When operating in cell 1, an intermediate reader WTRU may transmit sync messages with a timing given by the first message 502. Device 504 has been configured by the intermediate WTRU to perform AIoT transmission monitoring which matches the sync transmission associated with cell 1. As a result of mobility, the WTRU reader may be configured by cell 2 with a different timing of the sync messages 506. Such timing may no longer match the monitoring periods of the devices (device 504).

Described are solutions to ensure continuity of an AIoT operation during intermediate WTRU reader mobility which avoids interference on Uu resources and does not negatively impact (e.g., excessive power consumption) the AIoT devices.

A WTRU acting as an intermediate reader may receive, from a wireless network, a measurement event configuration (e.g., Ax/Bx measurement events) for reporting the status of an AIoT procedure (possibly along with measurements). The WTRU may transmit to multiple AIoT devices an AIoT paging message initiating an inventory procedure. If the configured event is satisfied, the WTRU may send a status report to the network, the status report containing, for example, an indication of whether an AIoT inventory procedure is ongoing, and requested resource timing based on monitoring cycle of one or more AIOT devices. The status report may allow the network to dynamically provide an AIoT transmission resource which can be safely used during a mobility event when such resource may be necessary.

The WTRU may receive, in an RRC message prior to a mobility event, resources for transmission of an AIoT message to one or more AIoT devices. A mobility event may be, for example, a radio link failure (RLF), a handover (HO), or a conditional handover (CHO). Upon a trigger of the mobility event (e.g., upon reception of a HO command, upon trigger of a CHO, upon starting T310), the WTRU may transmit an AIoT message (in the provided resource) to indicate an interruption of an AIoT procedure.

The interruption message may serve several purposes at the device: if a device is operating in DRX-like behavior the message can trigger a change in the monitoring cycle so that it can receive subsequent messages after the mobility event (since the reader transmissions may change their timing when operating on the new cell); the interruption message may contain the timing of the next paging message in the target (if the HO is complete); if a device is waiting for a response from a reader but is unable to receive it due to the interruption, the operation will not fail as a result as the interruption message can serve as a response (i.e., the device will not timeout); and if a device has succeeded random access and is being accessed in unicast, it will maintain the context until the end of the mobility event/procedure rather than assuming the unicast operation is complete.

Upon completion of the mobility event (e.g., HO completion, re-establishment to a new cell), the WTRU may transmit the status of the ongoing procedure to the network in a status report. The status report may contain, for example, a number of devices inventoried/left to inventory, a number of occasions used/remaining prior to the mobility event. The WTRU may receive a new resource configuration, containing, for example, a number of occasions, and a set of time/frequency resources. The WTRU may transmit on the AIoT interface, a new paging message containing at least an indication that an inventory procedure is being continued with a new set of resources. The indication to continue an inventory procedure may be used to provide information about devices that have successfully completed the inventory before the mobility to avoid initiating random access again, while others that had selected an occasion may reselect a new occasion in the new configuration.

As used herein, the terms device, AIoT UE, AIoT WTRU, and TAG are used interchangeably to mean the AIoT device that is being inventoried/queried by the reader.

The term reader may refer to the entity which queries the AIoT device, either directly, or via an intermediate WTRU as illustrated in FIG. 3B. The term reader in the description of FIG. 3B may also refer to the intermediate WTRU. In addition, the term reader may refer to a network node or a WTRU, depending on the context and/or the topology.

As used herein, the terms reader, network, intermediate UE/WTRU, may be interchangeably to mean the reader. This may result in a tradeoff between number of resources for random access, the size of the random ID (i.e., the number of unique IDs that can be selected), and the power consumption associated with the devices. Specifically, a large number of resources are not preferable because it increases the time required for the inventory procedure. The time can be shortened using less resources and increasing the size of the random ID. However, this will result in increased power consumption. If the same size of the random ID is used in all cases, the system may consume device power unnecessarily.

As used herein, inventory may refer to the overall procedure of a reader triggering access by multiple devices using a sequence of messages (e.g., similar to query, followed by query rep in RFID). The inventory procedure refers to a single round of attempts to have each device respond or attempt to respond with its access ID, or perform a RACH procedure. The inventory procedure may refer to a set of access occasions which may have 0 or at least 1 device respond within the access occasion.

An inventory procedure may occur similar to the legacy RFID procedure. Although referred to herein as inventory procedure, it may be termed differently in device requirements or specifications (e.g., query procedure, paging procedure, etc.).

As used herein, occasion refers to the opportunity for device transmission that may be delimited by the transmission of a query rep message (or similar). Specifically, a device may perform transmission in an occasion by performing an AIoT transmission in a defined time following the query rep associated with that transmission. Alternatively, an occasion may consist of both a time aspect and a frequency aspect.

A device may determine an occasion as a transmission following a specific query rep, and by transmitting on one of a number of frequencies (e.g., FDM). Wherever solutions indicate selection of an occasion, they may apply equivalently to selection of only a time component and/or selection of a frequency component.

Herein, depending on the solution or description, any reference to time can be associated with an absolute time measurement (e.g., seconds, slots, frames, etc.). Alternatively, it can refer to a number of executions of a procedure, possibly triggered by a reader (e.g., number of inventory procedures, number of accesses or RACH procedures, etc.). Alternatively, it can refer to a number of messages, possibly of a specific type, or containing specific information, as described herein, received or transmitted.

Configuration or pre-configuration may refer to any configuration received by a message (e.g., an RRC message, a MAC CE, a PHY layer signal, a data PDU, a control PDU associated with any or a new protocol layer, etc.) received from either a network node, or from another device or WTRU.

A device herein may be configured by the reader, whereby the reader may be a network node or a WTRU (e.g., intermediate WTRU as illustrated in FIG. 3B). In the case of a WTRU, the WTRU may derive the device configuration itself, or receive the device configuration from the network, in which case, the device configuration is being relayed from the network to the device by the WTRU. On the other hand, a WTRU configuration (in the case of an intermediate WTRU as illustrated in FIG. 3B) may be received from a network node (e.g., the gNB).

As used herein, the term resource (when referring to the AIoT interface) may refer to at least any of the following: a time/frequency resource in the traditional sense; a frequency resource which may be available at different times; and a time resource (possibly limited to one or more frequencies or frequency ranges) which starts from the transmission of a reader message and which lasts either a maximum period of time, or until the next transmission by the reader, possibly of a specific message.

In an example method or process, a reader may transmit (possibly periodic) indicators (e.g., an indication message) where the indicator may contain the location of a message in time, for example a paging message. The location of the message in time may be indicated in differently using different methods and the methods described herein would apply similarly for the different methods For example, the indicator may include the time gap/duration between when the indicator message ends and when the next paging message may be transmitted. A device, upon receiving the indicator, may determine to stop monitoring the R2D channel and enter a sleep state (e.g., to save power and/or harvest energy) for a duration determined by the duration indicated in the indicator, and may determine to wake-up and start monitoring the R2D channel to receive the paging message upon expiry of the duration.

FIG. 6 is an illustration of an example synchronization process according to an embodiment. In this example, device 604 may be OFF 610 (e.g., due to lack of sufficient energy) and miss the first paging message 606a. When device 604 has harvested enough energy, it wakes up (enters ON state 612a) and starts monitoring the R2D channel to receive the indicator 608. Device 604 receives indicator 608, determines the time gap/duration Tp (the unit of Tp may be one of seconds, chips, an indicted interval, etc.) until the next paging message 606b and enters sleep state 614. The device then may wake up and start monitoring the paging message 606b after Tp.

In an example, a first paging message may contain the time location of a second paging message. For example, a first paging message may indicate the time gap/duration from the end of the first paging message to the start of the second paging message. A device receiving the first paging message and determining that it is not paged may enter sleep state until the expiry of the indicated gap/duration when it may wake-up and start monitoring the R2D channel for the second paging message. The time durations may be measured in terms of seconds, chip durations, or in terms of the duration of a signal.

In an example, a first message may contain the time location of a second message wherein the messages may be transmitted during one inventory round, e.g., between two paging messages. The messages may be slot indicators and indicate the slot boundaries; these messages may also be referred to as random access triggering messages, for example QueryRep and/or Query messages (without loss of generality and for ease of description QueryRep is used as the message). For example, a first QueryRep message may indicate the time gap/duration from the end of the first QueryRep message to the start of the second QueryRep message. A device receiving the first QueryRep message and determining that it is not indicated to perform random access may enter a sleep state until the expiry of the indicated gap/duration when it may wake-up and start monitoring the R2D channel for the second QueryRep message. The time durations may be measured in terms of seconds, chip durations, or in terms of the duration of a signal.

In another example, the reader may send to the devices (e.g., in an interrupt message) the time location of the indicator, and in another example, the interrupt message may contain the indicator. The interruption message may contain any of the information in the indicator, or the indicator itself.

In yet another example, a device may enter sleep state during an inventory round, e.g., to save energy. For example, after receiving a paging message, the device may select slot #n (e.g., randomly) to attempt random access (e.g., by sending msg1 to the reader) and the device may enter sleep mode (for example, in a discontinuous manner) until slot #n arrives in which the device may perform random access. The following may parameters may apply to one or more embodiments.

Time duration between slot indicators may be fixed during an inventory round and may be indicated by the reader, for example in the paging message (the time duration between slot indicators may indicate a slot duration). Using the slot duration, a device may determine the starting time of the selected slot and enter sleep mode until that slot arrives in time.

A time duration may be indicated by the reader to the devices, e.g., in paging message. In one example, the time duration may be the minimum time between consecutive slot indicators. In another example, a device may receive a slot indicator and upon determining that the slot indicated in the slot indicator is not the slot selected by the device (e.g., for the purpose of performing random access) may enter a sleep state at least for the time duration indicated. Upon ending of the duration, the device may start monitoring the R2D channel.

The reader may transmit an indication message where the indication message may indicate to a device the duration left until the next slot indicator. The device may skip monitoring the R2D channel for the duration indicated in the indication message, e.g., the device may enter sleep state and wake-up to monitor the R2D channel after the duration ends. In one example, the indication message may be sent periodically by the reader during an inventory round. In another example, the indication message may be transmitted at time offset from the end of a slot indicator and continue being transmitted periodically until the next slot indicator. The periodicity of the indication message and the offset value (if used) may be indicated by the reader, for example in the paging message.

The above parameters (periodicity and time offset of the indication message, time duration (or a lower bound) between slot indicators) may be configured by the network at the reader.

In an example embodiment, the reader may send to the devices (e.g., in an interrupt message) the time location of the indication message. In another method, the interrupt message may contain the indication message.

Described herein are methods (at the reader and the device) for maintaining continuity of an AIoT operation during mobility of the reader WTRU. Specifically, a reader may initiate an AIoT operation (e.g., and inventory operation) and prior to completion of that operation, may trigger a mobility procedure. A mobility procedure may consist of any of the following (or combination/sequence of the following):
A handover (HO)
A conditional handover (CHO)
L1/L2 triggered mobility (LTM)
Conditional LTM
RLF
Re-establishment
Start of a connection timer (e.g., T310, T304, T311, etc.)
Expiry of a connection timer (e.g., T310, T304, T311, etc.)
Release to IDLE
Movement to an out of coverage state
Mobility to/from a U2N relay
Reconfiguration from the network (e.g., possibly of the AIOT resources usable by the reader UE)

The below figures show a subset of cases to which mobility applies as described herein.

A reader WTRU may ensure that an AIOT operation is maintained despite the mobility. The following illustrations show a subset of cases to which mobility applies as described herein.

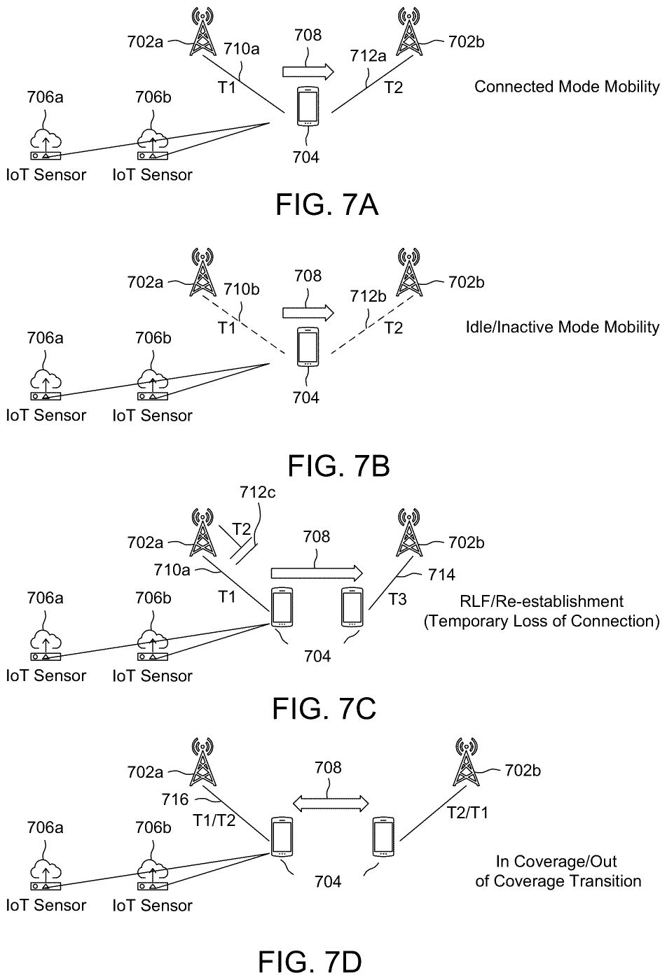

FIG. 7A illustrates a case with connected mobility. In an example embodiment, a WTRU may continue the AIoT operation during the mobility procedure. For example, reader WTRU 704 may continue transmission/reception of AIoT messages with IoT sensors 706a and 706b during the execution of the mobility procedure where WTRU 704 is in coverage of BS 702a and BS 702b via communication links 710a and 712a.

FIG. 7B illustrates a case with idle/inactive mobility. Reader WTRU 704 is in an idle or inactive state while acting as a reader for IoT sensors 706a and 706b. Neither communication link 710B nor 712b are in an active state.

FIG. 7C illustrates a case with RLF/Re-establishment mobility event. Reader WTRU 704 while acting as a reader WTRU for IoT sensors 706a and 706b experiences a communication link failure 712c. Reader WTRU 704 may reestablish communication with BS 702a via communication link 710a or Reader WTRU 704 may be handed over to BS 702b and establish communication via link 714. Thus, WTRU 704 may experience a temporary interruption, and may interrupt or suspend the AIoT transmissions during the mobility procedure but resume the operation at the point in which it was interrupted.

FIG. 7D illustrates a case with an out of coverage mobility event. WTRU 704 while acting as a reader WTRU for IoT sensors 706a and 706b may transition from in coverage of BS 702a to out of coverage with BS 702a and may reestablish communication link 716 with BS 702a.

A reader WTRU may ensure that an AIoT operation is maintained despite the mobility event/procedure. In one example embodiment, WTRU 804 may continue the AIoT operation during the mobility procedure. For example, reader WTRU 804 may continue transmission/reception of AIoT messages during the execution of the mobility procedure. In another example embodiment, WTRU 804 may interrupt or suspend the AIoT transmissions during the mobility procedure but resume the operation at the point in which it was interrupted. Herein, the terms interrupt, suspend, pause, etc. are used interchangeably. Specifically, the stage of the procedure (e.g., the access occasion number or remaining access occasions, the devices inventoried, the portion of the operation, etc.) remains unchanged during the interruption and is resumed following the completion of the mobility. In another example, a reader may perform some limited form of the operation during the interruption, such as the transmission of minimal responses, maintenance of synchronization of the devices, etc. In example embodiment, reader WTRU may interrupt an AIoT operation at initiation of the mobility, and upon completion of the operation, may determine whether to abort or continue the interrupted procedure.

A reader WTRU may determine whether to perform any of the solutions above (including possibly deciding which solution to apply) vs cancel an operation based on one or a combination of the following mobility events/procedures.

A Network indication, for example, upon triggering a handover command, the network may indicate (e.g., in the handover command) whether to interrupt the ongoing AIoT operation, or to cancel it. For example, such indication may be an explicit flag in the handover command. Alternatively, such indication may be implicit in the handover command (e.g., reception of a handover command containing resources for completion/continuation of the procedure in the target cell or during the handover may indicate to continue the operation).

Properties of the target cell of the mobility, for example, upon re-establishment to a cell which supports AIoT, a reader may continue an AIoT operation that was ongoing. If the cell to which a reader WTRU re-establishes does not support AIoT, the reader may abort the AIoT procedure. As another example, a reader WTRU may receive a handover command and may determine whether to interrupt and/or continue an AIoT operation or terminate/abort it based on whether the target cell supports AIoT (e.g., based on indication in the SIB). For example, the WTRU may make such determination by reading the SIB at or prior to reception of the handover command.

Type of mobility, for example, a WTRU may perform continuation of the operation for certain mobility events (e.g., HO, CHO), and may abort the operation for certain mobility events (e.g., RLF, re-establishment).

Duration of the mobility, for example, a WTRU may interrupt the operation at a mobility trigger and may abort the operation following this if the mobility operation is not completed prior to a configured time. For example, the UE may start a timer (Txxx) upon triggering the mobility. The WTRU may further interrupt the AIoT operation, or operate with limited transmission during the mobility. If the timer expires before completion of the mobility, the WTRU may abort the operation. The WTRU may determine the timer based on network configuration (e.g., dedicated signaling or SIB). Alternatively, the WTRU may determine the timer based on the type of AIoT operation (e.g., inventory vs command), the priorities of the AIoT operation (e.g., contention-based vs contention free), the specific transmission(s) pending for transmission by the reader, the device type currently involved in the operation, or any other property that determines which of the above solutions are used in the first place.

Type of and/or properties of the operation may consist of: whether the AIoT operation is an inventory or an inventory+command, and/or whether there is at least one of the inventoried devices to which a command needs to be issued; the number (possibly approximate) of devices being inventoried or referred to in the paging message; whether the paging/access on AIOT is contention-based or contention-free; and the QoS (e.g., latency, reliability, etc.) associated with the operation, possibly indicated to the reader UE.

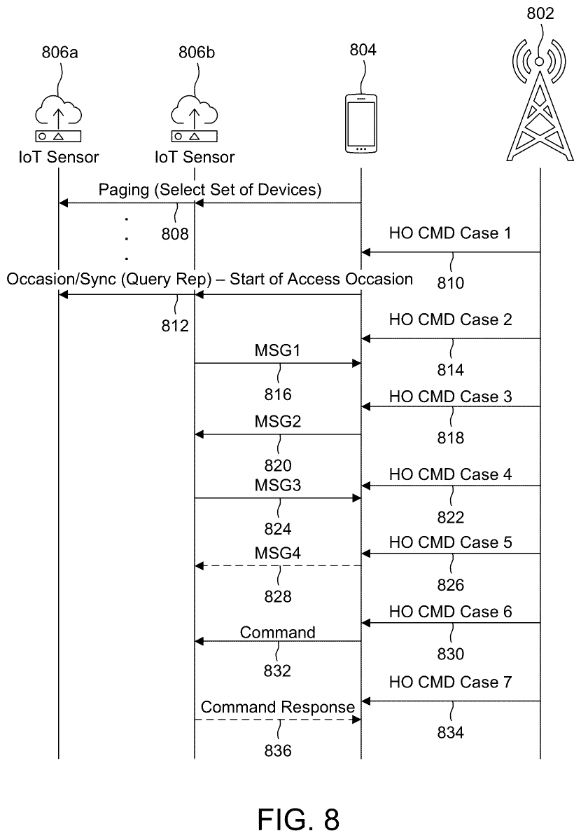

Status/progression of the operation may consist of: the number of or percentage of completed access occasions, inventory rounds, or similar; the number of or percentage of remaining access occasions, inventory rounds, or similar; the timing of the mobility trigger with respect to the different transmissions, such as whether the trigger is in between inventory rounds or during an inventory round, in the middle of an access occasion, between MSG1 reception and MSG2 transmission, etc. For example, different cases of the timing of the mobility trigger during random access are shown in the FIG. 8.

FIG. 8 is a diagram illustrating different cases of the timing of a mobility trigger during a random access.

In case 1, WTRU 804 may transmit a paging message to select IoT devices 806a and 806b, and in an example a WTRU 804 receives a handover command at 810. In case 2, WTRU 804 transmits the start of an occasion synchronization message (QueryRep) (inventory procedure) at 812, at 814 receives an handover command and at 816 receives MSG 1. In case 3, WTRU 804 receives a handover command at 818 and WTRU transmits MSG 2 and 820. In case 4, WTRU 804 receives a handover command at 822 and receives MSG 3 at 824. In case 5, WTRU 804 receives a handover command at 826 and transmits MSG4 at 828. In case 6, WTRU 804 receives a handover command at 830 and transmits an interruption message at 832. In case 7, WTRU 804 receives a handover command at 834 and receives a command response at 836.

A reader WTRU may maintain context associated with an AIoT operation during a mobility procedure when it decides to interrupt and/or continue an AIoT procedure (as opposed to abort/cancel the operation). Specifically, the reader may maintain identities, buffered AIoT data, state variables, counters, etc. Such maintenance of the context may occur during the mobility procedure. Such maintenance of the context may occur despite handover, re-establishment, re-keying, etc., which may occur as a result of a mobility procedure. On the other hand, in the case where an AIoT operation is aborted/cancelled, the reader may release the context associated with the operation.

A reader WTRU may maintain the following elements or information as part of the context.

Temporary device identities, for example, a reader may store a temporary device ID associated with each device which was successfully inventoried during the operation to that point (e.g., from the start of the operation to the mobility operation). The reader may then address the device after the mobility by using the temporary device ID. The reader may further determine whether to store the device ID or to release it despite interrupting and/or continuing the operation. For example, if the device was inventoried and there is no pending command to send to the device, the WTRU may release the temporary ID. For example, if the device was able to win the contention but did not send its inventory data in MSG3 yet, the WTRU may maintain the temporary ID.

Operation state variables, for example, a reader may store an index of the access occasion or access occasion group. For example, the reader may continue to number the access occasion or occasion groups from the stored index after the mobility based on having stored the value during the interruption time.

For example, a reader may store the state of a particular chain of message exchanges (e.g., MSG1, MSG2, MSG3, MSG4). For example, a reader may transmit message after the mobility based on the stored state of the chain (e.g., transmit the message where the reader left off in the chain).

Data received from the AIoT devices, for example, the reader may store the received data (e.g., MSG3 transmission, data from read command, etc.) from the devices that is received prior to the mobility. The reader may transmit the stored data to the network following the completion of the mobility event/procedure.

Data buffered for transmission in a Uu bearer, for example, a reader may maintain data buffered for transmission in a Uu bearer during the mobility procedure. Specifically, despite reconfiguration leading to reset of the Uu MAC, a reader may maintain buffered data for one or more logical channels associated with AIoT result transmission. Alternatively, the reader/WTRU may buffer the data and transmit it to the network after the mobility in an encapsulated control message (e.g., encapsulated in a NAS message, encapsulated in an RRC message, etc.) so as to re-establish the logical channels after the mobility.

In an example embodiment, a reader WTRU may transmit one or more messages to the network prior to or during a mobility operation. The purpose of the message may be, among others, to request resources for transmission on AIoT which can be safely used during the mobility operation. Such transmission may be used to prepare AIoT devices which are currently performing an AIoT operation. The status report may consist of an RRC message to the network, and IE included into an existing RRC message, a MAC CE (e.g., an existing MAC CE such as a BSR, etc.) or new MAC CE, or a transmission on PUCCH. In another example, the status report may consist of a RACH transmission. For example, if the reader WTRU is in IDLE/INACTIVE, it may perform RACH transmission in order to transmit the status report. Information associated with the status report may be, in such case, included based on selection of the random access preamble. Alternatively, information associated with the status report may be included as part of the random access procedure (e.g., in Uu MSG3, in the resume message, etc.).

A reader WTRU may be configured to transmit the status report based on one or a combination of any of the following.

Conditions related to the AIoT operation, for example, a reader WTRU may be configured to transmit the status message when there is an ongoing AIoT operation, such as during an inventory, during inventory+command operation, during command only, etc. In another example, a reader may be configured to transmit a status message based on conditions related to the type of AIoT operation, such as: for the case of an inventory and command operation only, for the case of a command only, etc.; and for the case the AIoT operation is a contention-based access, and for the case the AIoT operation is a contention-free access.

Conditions related to the AIoT operation for example, a reader WTRU may be configured to transmit the status message before or after a specific transmission planned by the reader that is part of the inventory and/or command procedure, for example: if another trigger herein occurs prior to transmission of MSG2 when the reader has received MSG1 from at least one device; if another trigger herein occurs prior to transmission of MSG4 when the reader has received MSG3 from at least one device; if another trigger herein occurs prior to MSG4 when the reader has incorrectly decoded MSG3 from at least one device; and if another trigger herein occurs prior to command transmission, when the device has been previously (already) been provided with the timing of the command transmission

Conditions related to the AIoT operation for example, a reader WTRU may be configured to transmit the status message if it had a planned/scheduled AIoT transmission within a configured time period following another trigger herein

Conditions related to the AIoT operation for example, a reader WTRU may be configured with a handover time, where the handover time is relative to reception of the HO command from the source cell. If the reader WTRU had been scheduled with, had a planned AIoT transmission, or had informed one or more devices of a planned AIoT transmission during the handover time, the reader WTRU may transmit the status message.

Triggers related to cell quality/coverage for example, a reader may transmit the status message upon detecting the cell quality falling below a configured threshold, possibly for a period of time.

Triggers related to cell quality/coverage for example, a reader may transmit the status message upon detecting one or more Ax-like events (events similar to or same as cell-related measurement events used for mobility) is triggered.

Triggers related to cell quality/coverage for example, a reader may be configured (e.g., in the mobility measurement event configuration) to include the status message with its measurement reports. If the WTRU has an ongoing AIoT operation, the reader may include the status report in the measurement reports to the network triggered based on mobility events.

Triggers related to loss of Uu connection, for example, a reader may trigger transmission of the status message upon triggering RLF. Triggers related to loss of Uu connection, for example, a reader may trigger transmission of the status message upon starting T310, possibly when another condition related to the AI0T operation is met. Triggers related to loss of Uu connection, for example, a reader may trigger transmission of the status message upon T310 expiry, possibly when another condition related to the AIoT operation is met. Triggers related to loss of Uu connection, for example, a reader may trigger transmission of the status message upon starting T311, possibly when another condition related to the AIoT operation is met. Triggers related to loss of Uu connection, for example, a reader may trigger transmission of the status message upon T311 expiry, possibly when another condition related to the AIoT operation is met.

Triggers related to loss of Uu connection, for example, a reader may trigger transmission of the status message upon detecting beam failure, possibly when another condition related to the AIoT operation is met. Triggers related to loss of Uu connection, for or example, a reader may transmit the status message upon reestablishment, either along with the re-establishment request, or following re-establishment. The reader may perform such transmission upon re-establishment based on another trigger (e.g., if such was triggered based on detecting RLF). Triggers related to loss of Uu connection, for example, whether transmission of the status message is performed or not, based on triggers herein, may further depend on whether the re-establishment is performed to the same/different cell, or same/different configured group/list of cells. For example, if the WTRU performs re-establishment to the same cell, or same group/list of cells, the status message may not be sent, otherwise, the status message may be sent.

Triggers related to connected mode mobility for example, a reader may transmit the status message upon receiving a handover command, possibly when another condition related to the AIoT operation is met. Triggers related to connected mode mobility for example, a reader may transmit the status message upon triggering a conditional handover, possibly when another condition related to the AIoT operation is met. Triggers related to connected mode mobility for example, a reader may transmit the status message along with the handover complete message to the target cell of a connected mode mobility. Triggers related to connected mode mobility for example, a reader may transmit the status message to the target cell following successful handover to the target cell (e.g., in an uplink RRC message following transmission of the complete message to the target cell.

Triggers related to idle/inactive mode mobility, for example, a reader may transmit the status message upon triggering a cell reselection, possibly when another condition related to the AIoT operation is met, possibly when another condition related to the AIoT operation is met.

Network trigger, for example, a reader may receive a request from the network (e.g., in an RRC message, in a MAC CE, etc.) to transmit a status report. For example, the network may request a status report from the reader WTRU prior to a handover, or immediately following a handover.

A reader may transmit one or more of the following in the status report:

Information related to the type/current status/progress of an AIoT operation for example, the reader may indicate (implicitly or explicitly) that an AIoT operation is ongoing/in progress. Information related to the type/current status/progress of an AIoT operation example, the reader may indicate the number of occasions elapsed/remaining in an inventory procedure. Information related to the type/current status/progress of an AIoT operation for example, the reader may indicate (implicitly or explicitly) whether one or more devices currently has an active unicast communication with the reader (e.g., the device has successfully completed random access, and is currently being accessed by the reader for AIoT commands) and/or the specific device. For example, such may include the number of such devices that are in unicast and/or their device IDs. Information related to the type/current status/progress of an AIoT operation for example, the reader may indicate that it has received at least one MSG1 transmission and did not respond with MSG2.

Information related to the type/current status/progress of an AIoT operation for example, the reader may indicate the type of operation (inventory, inventory+command, command only). Information related to the type/current status/progress of an AIoT operation for example, the reader may indicate the number of devices associated with the inventory, or the number of devices expected to respond based on the device IDs or device ID group/mask included by the reader in the paging message. Information related to the type/current status/progress of an AIoT operation for example, the reader may include any information that was included in the AIOT paging message sent to the devices, possibly associated with the current AIoT operation

Information related to a specific device to which the reader is communicating for example, the reader may include the device identities of the devices, possibly limited to devices which have ongoing/pending command operation following successful random access by the device. For example, the reader may derive/determine/receive a temporary identity for each device that succeeds random access during an inventory procedure (for the purposes of addressing the device during subsequent commands). For example, the device identity may the identity selected by the device during the random access. Alternatively, the reader may assign an identity to the reader. The reader may send the identity, along with other status information about the AIoT operation specific to that device, to the network in the status message.

Information related to a specific device to which the reader is communicating for example, the reader may include an indication of stored device energy associated with a specific device, which was received in a message sent by the device to the reader. Information related to a specific device to which the reader is communicating for example, the reader may include an indication of whether a device has segmented a data transmission. Information related to a specific device to which the reader is communicating for example, the reader may include an amount of data pending at the device for transmission, which may have been received from the device during the ongoing AIoT operation

Information related to the location of a specific device for example, the reader may include the measurements of the device's transmission (e.g., average RSSI, signal quality, etc.). Information related to the location of a specific device for or example, the reader may include a measure of proximity of the device's transmission (e.g., an index associated with an RSSI range of the device's transmission, an index associated with transmit power of the reader transmission which allowed the reader to receive a device's response, etc.).

Information related to a specific AIoT resource, possibly associated with a device for example, the reader may include information about specific resources it already assigned to one or more devices during an ongoing AIoT operation. For example, a reader may provide the network with the time/frequency resource associated with an AIoT device, for example, for transmission by the device of MSG3, for example, for transmission by the device of data associated with a command, for example, for reception of a paging message from the reader, for example, for reception of MSG2 from the reader, for example, for reception of a command and/or MSG4 from the reader.

Information related to a specific AIoT resource, possibly associated with a device for example, the reader may provide to a device (e.g., in MSG2 transmission or in a sync message transmission) the timing/resource of the next paging message or command message to be transmitted to that device. Following this indication to the device, the reader may experience a mobility. The reader may provide this timing/resource in the status report

Information related to a specific AIoT resource, possibly associated with a device for example, the reader may provide the frequency resource associated with a device's transmissions. Specifically, a device may select a frequency resource to be used for its transmissions. This may correspond to the frequency used to transmit MSG1. All subsequent resources for device transmission may occur in the same frequency, and the reader may report the frequency associated with a given device.

Information related to a specific AIoT resource, possibly associated with a device for example, the reader may provide the periodicity and/or timing offset of resources used for transmission of the synchronization message (i.e., the message used to signal the time occasion which allows multiple TDM resources within the time occasion). Information related to a specific AIoT resource, possibly associated with a device for example, the reader may provide information of a semi-static assignment of resources made by the reader to a device or group of devices.

Information related to the results of the AIoT operation, for example, the reader may include the results of inventory of any devices which have responded to the ongoing AIoT operation to that point. Information related to the results of the AIoT operation, for example, the reader may include the number of failed AIoT interactions to that point, such as, detected MSG1 transmissions for which the reader was not able to decode ID in MSG1 (due to collisions), the number of detected collisions for MSG1, the number of devices (and possibly the MSG1 identity of the devices) for which MSG3 transmission was not decoded.

In an example embodiment, a reader WTRU may stop or interrupt transmission of an AIoT transmission (e.g., regular indications of the start of access occasion or access occasion groups, a periodic or regular synchronization signal, a DRX pattern or activity indication, etc.) during a mobility. For example, the reader WTRU may stop transmission of AIoT transmission: between the reception of the handover command from the source cell and successful transmission of the complete message to the target cell, between the reception of the handover command from the source cell and reception of the first reconfiguration (or a reconfiguration containing AIoT configuration) from the target cell, between start of T310 and PHY later recovery (stop of T310), between start of T310 leading to RLF and successful re-establishment, between start of T310 leading to RLF and reception of the first reconfiguration (or a reconfiguration containing AIoT configuration) after re-establishment, between RLF and successful re-establishment, between HO failure and successful re-establishment, and between RLF and reception of the first reconfiguration (or a reconfiguration containing AIoT configuration) after re-establishment.

A reader WTRU may resume counting or identification associated with its regular transmissions following the second trigger or the resume of the transmission. For example, the occasion indication transmissions may contain an index associated with an occasion number or occasion group number. The reader may continue the numbering from the previously transmitted value after the completion of the mobility.

In an alternative embodiment, the reader may determine whether to repeat the same occasion number from the previous transmission (where such transmission may have occurred prior to the mobility), or to increment the occasion number based on any or a combination/comparison of: the timing of the first mobility trigger, the AIoT reception/transmission pending at the reader when the first mobility trigger occurred, the last AIoT message received/transmitted by the reader prior to the first mobility trigger or completion of the mobility, the ability of the reader to transmit after the mobility trigger, whether a transmission by one or more devices is received in a time opportunity (e.g., the occasion announced by the previous occasion sync message or the occasion interrupted by the mobility trigger), the type of mobility trigger, whether the mobility was successful or not, and whether the mobility was to the same cell (e.g., RLF followed by recovery to the same cell) or to a different cell (e.g., handover)

In an example embodiment, if the reader WTRU receives MSG1 transmission from at least one device before or during the mobility, but is unable to transmit MSG2 due to having received the mobility trigger, the reader WTRU may repeat the same occasion number from the previous transmission. On the other hand, if MSG2 was transmitted (either prior to the first mobility trigger, or within a resource allowing transmission during mobility), the reader WTRU may increment the occasion number.

In an example embodiment, a reader WTRU may transmit one or more messages on the AIoT interface during a mobility procedure. The purpose of the message may be, among others, to inform one or more devices of an interruption and/or change in an AIoT operation caused by the mobility of the reader. Such message may be a standalone message transmitted by the AIoT MAC layer or L2 of the WTRU reader. Alternatively, the AIoT PHY layer may transmit a message/signal which may operate as a such a message. Alternatively, the interruption message may be piggybacked on a L2 or L1 message used for other purposes. For example, the interruption message may consist of an indication or an information element included with an AIoT paging message, a R2D synchronization message, a random access message (e.g., MSG2), etc.

A reader WTRU may be configured to transmit the interruption message based on one or a combination of the following conditions/triggers:

Conditions related to the AIoT operation, for example, a reader WTRU may be configured to transmit the interruption message when there is an ongoing AIoT operation, such as during an inventory, during inventory+command operation, during command only, etc. Conditions related to the AIoT operation, for example, a reader WTRU may be configured to transmit the interruption message before or after a specific transmission planned by the reader that is part of the inventory and/or command procedure, for example: if another trigger herein occurs prior to transmission of MSG2 when the reader has received MSG1 from at least one device. Specifically, the reader WTRU has a pending MSG2 transmission, if another trigger herein occurs prior to transmission of MSG4 when the reader has received MSG3 from at least one device. Specifically, the reader WTRU has a pending MSG4 transmission, if another trigger herein occurs prior to MSG4 when the reader has incorrectly decoded MSG3 from at least one device, if another trigger herein occurs prior to command transmission, when the device has been previously (already) been provided with the timing of the command transmission

Conditions related to the AIoT operation, for example, a reader WTRU may be configured to transmit the interruption message if it had a planned/scheduled AIoT transmission within a configured time period following another trigger herein. For example, a reader WTRU may be configured with a handover time, where the handover time is relative to reception of the HO command from the source cell. If the reader UE had been scheduled with, had a planned AIoT transmission, or had informed one or more devices of a planned AIoT transmission during the handover time, the reader WTRU may transmit the interruption message.

Triggers related to cell quality/coverage for example, a reader may transmit the interruption message upon detecting the cell quality falling below a configured threshold, possibly for a period of time. Triggers related to cell quality/coverage for example, a reader may transmit the interruption message upon detecting one or more Ax-like events (events similar to or same as cell-related measurement events used for mobility) is triggered. Triggers related to cell quality/coverage for example, a reader may transmit the interruption message upon determining that it is out of coverage, possibly for a configured period of time, possibly when another condition related to the AIoT operation is met

Triggers related to loss of Uu connection for example, a reader may transmit the interruption message upon detecting RLF, possibly when another condition related to the AIoT operation is met. Triggers related to loss of Uu connection for example, a reader may transmit the interruption message upon starting T310, possibly when another condition related to the AIOT operation is met. Triggers related to loss of Uu connection for example, a reader may transmit the interruption message upon T310 expiry, possibly when another condition related to the AIoT operation is met. Triggers related to loss of Uu connection for example, a reader may transmit the interruption message upon starting T311, possibly when another condition related to the AIoT operation is met. Triggers related to loss of Uu connection for example, a reader may transmit the interruption message upon T311 expiry, possibly when another condition related to the AIoT operation is met. Triggers related to loss of Uu connection for example, a reader may transmit the interruption message upon detecting beam failure, possibly when another condition related to the AIoT operation is met

Triggers related to connected mode mobility for example, a reader may transmit the interruption message upon receiving a handover command, possibly when another condition related to the AIoT operation is met. Triggers related to connected mode mobility for example, a reader may transmit the interruption message upon triggering a conditional handover, possibly when another condition related to the AIoT operation is met.

Triggers related to idle/inactive mode mobility for example, a reader may transmit the interruption message upon triggering a cell reselection, possibly when another condition related to the AIoT operation is met, possibly when another condition related to the AIoT operation is met

A reader WTRU may include one or more of the following in the interruption message to the devices. An indication of time (either in terms of absolute time [e.g., ms], number of slots, number of AIoT occasions—possibly delimited by a synchronization signal, etc.). Specifically, the reader may provide an indication of time associated with a specific future transmission by the reader, possibly to occur after the mobility. For example, the reader may receive a time value from the network in a handover command. The reader may include the time value in the interruption message. The time may represent a (minimum) amount of time corresponding to the retransmission of the paging message by the reader following the handover.

The reader may provide the time (e.g., minimum time, maximum time, expected time) in which the reader is expected to not be able to transmit. Such information can be received in the network (e.g., in the handover command) or may be configured for each type of mobility operation. Such time may be used as a sleep time by the device, for example, to allow the device to trigger charging.

The reader may provide a time offset which represents the time difference between a transmission or a type of reader transmission while controlled by the source cell and the transmission or type of transmission when controlled by the target cell. The offset may be provided by the network (e.g., in the handover command).

The reader may transmit a control element, signal, sequence, etc. which signals the interruption event to one or more devices, where the interruption event is associated with a mobility operation at the relay. For example, a WTRU may include the flag or message in a message which is part of the AIoT procedure, such as MSG2 transmission, MSG4 transmission, paging message, synchronization transmission from the physical layer, etc.

For example, a WTRU may include a flag or physical layer control element in the synchronization message to cancel a previously indicated or derived resource to be used by the device. A WTRU may include a control element in a L2 message (e.g., MSG2) with a new or alternate resource allocation for the transmission of MSG3 to be performed by the device (e.g., in the case where MSG3 resource is generally determined based on MSG1, MSG2, or sync transmission timing.

The reader may transmit a configuration indicating a pattern of active transmission by the reader. This can be used by the device to determine periods for which the device should perform active monitoring/transmission and periods for which the device should perform sleep/charging. The pattern of active transmission may represent the pattern associated with the target cell (i.e., what timing the reader will transmit when the mobility to the target cell is complete). Alternatively, the pattern of active transmission may represent the pattern to use during the mobility (e.g., while T310 is running, following RLF until re-establishment occurs, etc.).

In an example, as part of the interruption message transmission, the reader may further include information or a transmission that is associated with an AIoT operation. Specifically, the reader may perform only a subset of transmissions associated with the ongoing operation during the mobility, or following the trigger of mobility. For example, if a mobility trigger occurs following reception of MSG1 by a set of devices, the reader may transmit MSG2 as part of the interruption message.

The reader WTRU may obtain any of the above information from the network, or derive such from information obtained from the network. Specifically, the reader WTRU may receive the information above in the handover command, for the case of a mobility triggered by a handover. The reader WTRU may receive the information above in SIB, for the case of a mobility triggered by RLF.

The reader WTRU may transmit the interruption message and/or any AIoT messages transmitted during the mobility in a resource determined by one or more of the following methods: a dedicated resource or set of resources obtained in the handover command, a dedicated resource or set of resources provided (e.g., in a reconfiguration) prior to the handover command to be used for the purpose of transmitting the interruption message, a resource or set of resources reserved by the source cell for transmission of the interruption message. For example, such resource may be cell specific and indicated in the SIB.

In an example embodiment, such resources may be provided in a dedicated configuration by the cell. The resource may be further activated based on an event (e.g., measurement event, successive HARQ feedback failure, etc.). For example, the reader WTRU may configured with an Ax event associated with the use of a previously configured resource. If the reader WTRU triggers such Ax event, the reader WTRU may be allowed to use the resource for transmission of AIoT data. A reader WTRU may further be allowed to transmit on such resource if a mobility trigger (e.g., RLF, HO, etc.) occurs within a configured period of time following the trigger of the Ax event. Specifically, if the WTRU does not trigger a mobility event within the time period following the Ax event, the reader may assume the resource to no longer be assigned to the reader WTRU. Alternatively, the reader may be allowed to use the resource immediately following trigger of the Ax event, possibly for a period of time following the Ax event, or until the mobility event (or whichever occurs first).

In one or more embodiments, a reader WTRU may use the interruption message to signal an interruption in an ongoing AIoT operation (e.g., inventory) at a first mobility trigger (e.g., start of the mobility). The AIoT operation may be interrupted during the mobility until a second trigger (e.g., end of the mobility). The second trigger may initiate continuation of the mobility by the reader WTRU by initiating a transmission at the reader WTRU which resumes the AIoT operation. The second trigger may initiate a second transmission by the reader to resume the AIoT operation.

In another example embodiment, a reader WTRU, upon a first mobility trigger (e.g., reception of a handover command), may determine to transmit an interruption message along with MSG2 if the mobility trigger occurs prior to the transmission of MSG2. Specifically, the reader WTRU may use the resource(s) provided in the handover command to transmit MSG2 along with the interruption message. The reader WTRU may include, in the transmission of MSG2, a control element which indicates the mobility trigger and/or a period of time expected for the arrival of a new message which allocates the MSG3 resource. The reader may stop transmission of the regular sync message representing occasion or occasion groups following the first mobility trigger. Following the first mobility trigger, if a second mobility trigger (e.g., successful transmission of the complete message at handover completion, successful re-establishment following handover failure, reception of a new configuration of AIoT resources following handover/re-establishment) has occurred before the expiry of the time period, the WTRU may resume the operation. Specifically, the reader WTRU may re-initiate transmission of the regular sync message representing occasion or occasion groups. Otherwise, if the second mobility trigger does not occur, possibly within a configured time period (possibly the same time period provided in the handover command, possibly a different configured time period), the reader WTRU may cancel the ongoing AIoT operation.

In another example embodiment, a reader WTRU may transmit MSG2 and replace the resource allocation (normally used to assign a resource for the device's transmission of MSG3) with the interruption message. For example, the interruption message may contain an indication of the mobility procedure. Alternatively, the interruption message may indicate a resource for MSG3 transmission at the device which is relative to the transmission of a subsequent completion message transmitted by the reader following the mobility (e.g., a sync message). Following completion of the mobility procedure, the reader may transmit the subsequent message and may expect transmission by the device following the subsequent message (using FDM and/or TDM relative to this subsequent message which was sent in the interruption message. In another alternative, the interruption message may indicate the interruption (possibly with an indication to sleep for a time period), and the device will understand this to mean that the allocation for MSG3 will come along with the subsequent message transmitted after the mobility. The reader may transmit the allocation in the subsequent message which indicates completion of the mobility.

In an example embodiment, a reader WTRU which completes a mobility procedure may trigger a BSR to report any buffered data (associated with Uu logical channels maintained during the mobility procedure) that was received from devices prior to the mobility procedure. Such data may represent (partial) results of the AIoT operation. The WTRU may trigger the BSR upon reconfiguration received after the mobility procedure. Alternatively, the WTRU may trigger the BSR immediately following completion of the mobility procedure (e.g., successful transmission of the complete RRC message).

A device may receive an interruption message in any of the reader transmissions described herein. A device may perform the following reception of the interruption message: disable, cancel, pause a response timer, initiate a second timer (possibly provided by the reader or configured), enable sleep mode, for a period of time, reselect a new occasion, possibly based on the remaining occasions, (Re)transmit MSG1 in an occasion following completion of the mobility, Maintain transmitted data buffered in MSG3, trigger retransmission of a previous data transmission, perform transmission depending on, and change its on/off/sleep pattern.

Regarding an interrupt message to disable, cancel, pause a response timer, a device may be configured with a response timer (e.g., failure or success) associated with an AIoT operation. For example, the response timer may be associated with the following behaviors: following MSG1 transmission, if MSG2 transmission is not received for a particular time, the device assumes MSG1 transmission has failed and either performs retransmission of MSG1 (in the same or different occasion or inventory round), or assumes the inventory procedure has failed; following MSG3 transmission, if a subsequent unicast message addressed to the device is not received within a particular time, the device assumes MSG3 transmission to be successful and/or no subsequent command message is to be received during the current inventory procedure; following wakeup from sleep during an inventory procedure (e.g., device not monitoring channel), if the device does not receive a synchronization message with an indicated occasion number or a paging message within a configured time, the device may assume the AIoT operation has failed; following reception of a first synchronization message, possibly indicating an access occasion, if the device does not receive a second synchronization message, possibly indicating an access occasion, the device may assume the inventory or command procedure has failed following reception of MSG2, if the device does not receive a resource allocation for MSG3 transmission, the device may assume that inventory procedure has failed.

In any of the above cases, if the device receives an interruption message, the device may stop, disable, pause any of the above timers. A device may further resume or restart such timer upon completion of the mobility, possibly indicated by a subsequent transmission by the WTRU reader.

Regarding an interrupt message to initiate a second timer (possibly provided by the reader or configured), a device may initiate a timer upon reception of the interruption message. For example, the value of such timer may be (pre)configured, or may be provided by the WTRU (e.g., in the interruption message, in the paging message, etc.). The device may stop such timer upon successful completion of the mobility operation and/or reception of a transmission from the reader WTRU (indicating successful completion of the mobility. If the timer expires, the device may assume failure of the AIoT operation.

Regarding an interrupt message to enable sleep mode, for a period of time, a device may initiate a period of sleep upon reception of an interruption message. Such period of sleep may be associated with maintaining variables, registers, context, etc. associated with an ongoing operation, not performing monitoring of AIoT transmission, initiating energy harvesting, etc. The amount of sleep time may be (pre)configured or provided by the reader WTRU (e.g., in the interruption message, in a paging message, etc.).

Regarding an interrupt message to reselect a new occasion, possibly based on the remaining occasions, a device may select a new occasion (e.g., for transmission of MSG1). For example, a device may perform occasion selection upon reception of a paging message. If a device receives an interruption message from the reader, it may perform reselection of a new occasion, possibly considering the occasions remaining in the inventory, possibly to occur after the completion of the mobility. In an example embodiment, a device may maintain/keep the same selected occasion (i.e., it may perform MSG1 transmission in the same occasion it had initially selected, if the occasion occurs following the mobility. A device may further determine to instead reselect a new occasion based on the occurrence of some events/conditions, such as: the device receives a new number of occasions and/or resource configuration from the reader, possibly in the interruption message, possibly in a reader transmission after successful completion of the mobility; the device receives an explicit indication from the reader (e.g., in the interruption message, in another reader transmission occurring after successful mobility procedure) to perform reselection; the interruption message is received by the device during the initially selected occasion; the interruption message is received by the device following MSG1 transmission but prior to reception of MSG2 (or prior to the maximum or minimum time allowed between MSG1 transmission and MSG2 reception)

Regarding an interrupt message to (re)transmit MSG1 in an occasion following completion of the mobility, in an example embodiment, possibly in the case where the interruption message is received in the occasion selected by the device, the device may (re)transmit MSG1 in an occasion following completion of the mobility. The device may use the first occasion after successful mobility. Alternatively, the device may select a new occasion from the remaining occasions after the mobility.

Regarding an interrupt message to maintain transmitted data buffered in MSG3, a device may transmit MSG3. If the device receives an interruption message following MSG3 transmission (e.g., before a timer expires following MSG3 transmission, before reception of an additional message such as an acknowledgement message or a command message, etc.), the device may maintain the data transmitted in MSG3 as buffered data. Otherwise, the device may release the data transmitted in MSG3.

Regarding an interrupt message to trigger retransmission of a previous data transmission, a device may perform a retransmission of a previous data transmission (e.g., MSG3, command response, etc.). This may apply to cases where the interruption message is received following to perform transmission depending on a certain condition or where there is a change its on/off/sleep pattern.

Herein, transmission/reception of the interruption message may also be understood as interruption of the sync transmission messages. For example, the device behaviors described herein based on reception of the interruption message may alternatively be performed by the device upon detecting an absence of regular synchronization/occasion start message transmission by the reader.

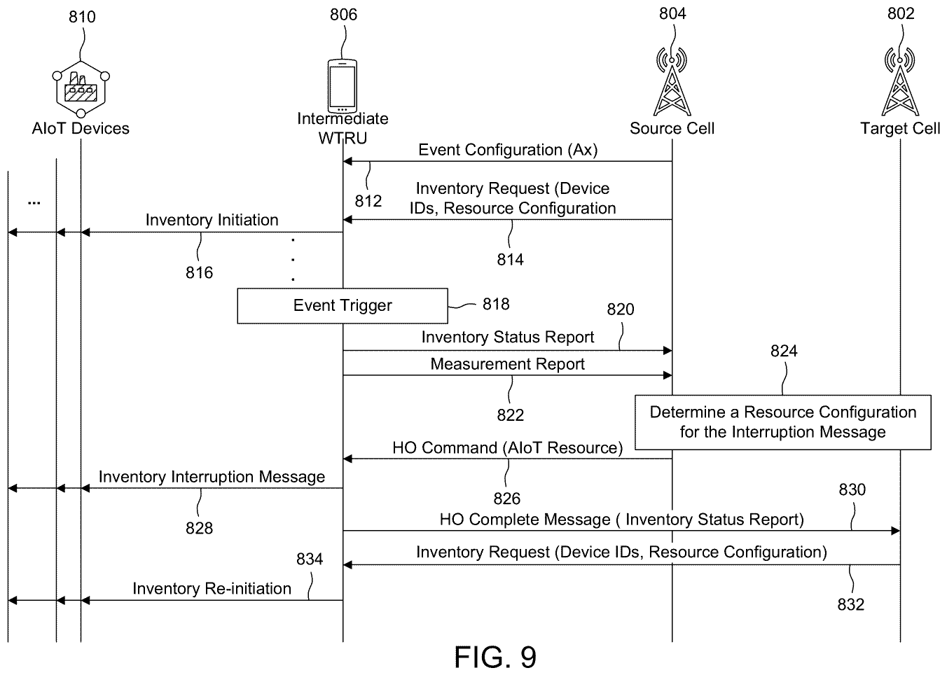

FIG. 9 is a signal flow diagram illustrating an example process of an intermediate WTRU experiencing a handover mobility event.

WTRU 806 is acting an intermediate device between a wireless network and one or more AIoT devices 810. This is similar to a topology illustrated in FIG. 3B. At 812, WTRU 806 receives a measurement event configuration (e.g., Ax/Bx measurement events) from Source Cell 804 for reporting the status of an AIoT procedure (possibly along with measurements). At 814, WTRU 806 receives an inventory request from Source Cell 804. It should be understood that the inventory request may be received with the event configuration such that the information received at 812 and 814 may be received together or at the same instance.

At 816, WTRU 806 transmits a message to one or more AIoT devices 810 initiating an inventory procedure, and at 818 WTRU 806 detects a mobility event. At 820, WTRU 806 transmits an inventory status report to Source Cell 804. The status report may contain an indication of whether an AIoT inventory procedure is ongoing and a requested resource timing based on monitoring cycle of one or more AIoT devices 810. The purpose of the status report may be to allow the network to dynamically provide an AIoT transmission resource which can be safely used during the mobility when such resource may be necessary. At 822, WTRU may transmit a measurement report. Transmission of the measurement report may depend on the type mobility event detected at 818. In addition, WTRU 806 may receive an RRC message prior to the mobility event (e.g., RLF, HO, CHO), indicating resources for transmission of an AIoT message to the one or more AIoT devices 810.

Assuming the mobility event detected at 818 is a handover, at 824 Source Cell 804 and Target Cell 802 determine a resource configuration for transmission of an inventory interruption message. At 826, WTRU 806 receives a handover command. The handover command includes AIoT resources for the inventory interruption message. WTRU 804 transmits the inventory interruption message to AIoT devices 810 at 828.

As a general description and not specifically directed to a handover command, upon trigger of the mobility event (e.g., upon trigger of RLF, upon trigger of a CHO, upon starting T310), WTRU 806 transmit an AIoT message (in the provided resource) to indicate an interruption of an AIoT procedure. The interruption message can serve several purposes at the AIoT device. If a device is operating in DRX-like behavior the message can trigger a change in the monitoring cycle so that it can receive subsequent messages after the mobility (since the reader transmissions may change their timing when operating on the new cell); the interruption message can contain the timing of the next paging message in the target cell (if the HO is complete); if a AIoT device is waiting for a response from a reader but is unable to receive it due to the interruption, the operation will not fail as a result as the interruption message can serve as a response (i.e., the device will not timeout); and if a device has succeeded random access and is being accessed in unicast, it will maintain the context until the end of the mobility procedure rather than assuming the unicast operation is complete.

At 830, upon completion of the mobility event (handover completion and re-establishment to a new cell) WTRU 806 may transmit a handover complete message to Target Cell 802. The handover complete message may include an inventory status report for one or more of AIoT devices 810. The inventory the status report may contain, for example, a number of devices inventoried/left to inventory and a number of occasions used/remaining prior to the mobility.

WTRU 806, at 832 may receive an inventory request that includes a new resource configuration from Target Cell 802. The new resource configuration may contain, for example, a number of occasions and a set of time/frequency resources. At 834, WTRU 806 may transmit an inventory re-initiation. The inventory re-initiation may include, for example, an indication that an inventory procedure is being continued with a new set of resources. The indication to continue an inventory procedure may be used to inform AIoT devices that have successfully completed the inventory before the mobility to avoid initiating random access again, while other AIoT devices that had selected an occasion may reselect a new occasion in the new configuration.

Thus, as illustrated in FIG. 9, intermediate WTRU 806 receives an event configuration (e.g., an Ax event configuration) at 812. The event configuration configures the events for measurement reporting. It also configures the behavior intermediate WTRU 806 to report information to Source Cell 804 to help configuration of the resource for the interruption message (e.g., status of the inventory procedure, remaining devices to inventory, etc.). Source Cell 802 may transmit an inventory request at 814. At 816, WTRU 802 may initiate an inventory procedure (e.g., based on trigger from the core network). An event configured by the Ax events may be triggered during the inventory procedure at 818. At 822, WTRU 806 may report mobility measurements along with (in the same or different RRC message) information about the status of the ongoing inventory procedure at 820. Based on the status, at 824, the Source Cell 804 and Target Cell 802 may coordinate a resource that can be used for transmission of the interruption message by intermediate WTRU 806. This resource is sent by Source Cell 804 along with the HO command at 826. Upon reception of the HO command, intermediate WTRU 806 may transmits the interruption message and suspends the AIoT procedure (e.g., stops transmission on the AIOT interface) at 828. Upon completion of the handover, intermediate WTRU 806 may transmit an additional/alternate inventory status report message to the network, possibly along with the HO complete message at 830. Intermediate WTRU 806 may receive an inventory request from Target Cell 802 at 832. Intermediate WTRU 806 may then re-initiate the inventory procedure at 828. The inventory procedure may be re-started with a new set of resources (e.g., a new number of occasions representing the remaining devices to inventory). In such case, intermediate WTRU 806 may transmit a new paging message to restart a new inventory at 834. Alternatively, the suspended inventory procedure may be resumed from where it left off, whereby intermediate WTRU may re-initiate transmission of the occasion/sync messages and/or any resource allocation information that is pending based on information in the interruption message.

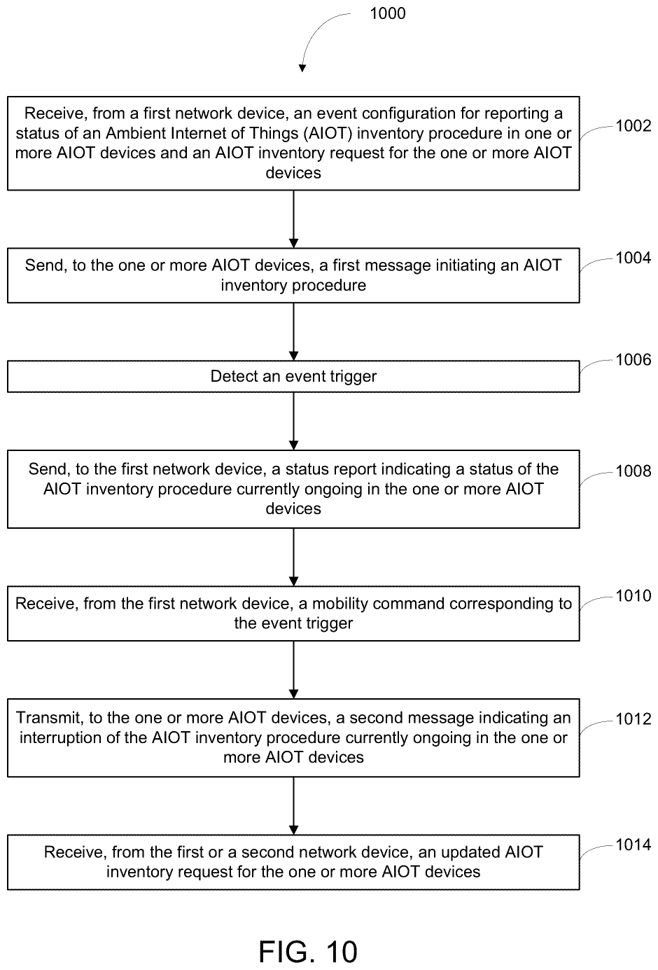

FIG. 10 is a flowchart of an example process 1000. In some implementations, one or more process blocks of FIG. 10 may be performed by a WTRU.

As shown in FIG. 10, process 1000 may include receiving, from a first network device, an event configuration for reporting a status of an Ambient Internet of Things (AIOT) inventory procedure in one or more AIoT devices and an AIOT inventory request for the one or more AIOT devices at 1002. For example, a WTRU may receive, from a first network device, an event configuration for reporting a status of an AIoT inventory procedure in one or more AIoT devices and an AIoT inventory request for the one or more AIoT devices, as described above. As also shown in FIG. 10, process 1000 may include sending, to the one or more AIoT devices, a first message initiating an AIoT inventory procedure at 1004. For example, the WTRU may send, to the one or more AIoT devices, a first message initiating an AIoT inventory procedure, as described above. As further shown in FIG. 10, process 1000 may include detecting an event trigger at 1006. For example, the WTRU may detect an event trigger, as described above. As also shown in FIG. 10, process 1000 may include sending, to the first network device, a status report indicating a status of the AIoT inventory procedure currently ongoing in the one or more AIoT devices at 1008. For example, the WTRU may send, to the first network device, a status report indicating a status of the AIoT inventory procedure currently ongoing in the one or more AIoT devices, as described above. As further shown in FIG. 10, process 1000 may include receiving, from the first network device, a mobility command corresponding to the event trigger at 1010. For example, the WTRU may receive, from the first network device, a mobility command corresponding to the event trigger, as described above. As also shown in FIG. 10, process 1000 may include transmitting, to the one or more AIoT devices, a second message indicating an interruption of the AIoT inventory procedure currently ongoing in the one or more AIoT devices at 1012. For example, the WTRU may transmit, to the one or more AIoT devices, a second message indicating an interruption of the AIoT inventory procedure currently ongoing in the one or more AIoT devices, as described above. As further shown in FIG. 10, process 1000 may include receiving, from the first or a second network device, an updated AIoT inventory request for the one or more AIoT devices at 1014. For example, the WTRU may receive, from the first or a second network device, an updated AIoT inventory request for the one or more AIoT devices, as described above. As also shown in FIG. 10, process 1000 may include transmitting, to the one or more AIoT devices, a third message containing at least an indication that the AIoT inventory procedure is being continued in the one or more AIoT devices at 1016. For example, the WTRU may transmit, to the one or more AIoT devices, a third message containing at least an indication that the AIoT inventory procedure is being continued in the one or more AIoT devices, as described above.

Process 1000 may include additional implementations, such as any single implementation or any combination of implementations described below and/or in connection with one or more other processes described elsewhere herein. In a first implementation, the status report includes at least one of an indication of whether the AIoT inventory procedure is ongoing, and a requested resource timing based on a monitoring cycle of the one or more AIoT devices.

In a second implementation, alone or in combination with the first implementation, the updated AIoT inventory request includes an updated resource configuration for transmitting the updated AIoT inventory request to the one of more AIoT devices, the updated resource configuration including at least one of a number of access occasions or a set of time and frequency resources for transmitting the updated AIoT inventory request to the one or more AIoT devices.

In a third implementation, alone or in combination with the first and second implementation, the inventory procedure is resumed in the one or more AIoT devices using the updated resource configuration. In a fourth implementation, alone or in combination with one or more of the first through third implementations, the event trigger is one of: a radio link failure (RFL), a handover (HO), or a conditional handover (CHO).

In a fifth implementation, alone or in combination with one or more of the first through fourth implementations, the mobility command includes a resource configuration for transmitting the second message. In a sixth implementation, alone or in combination with one or more of the first through fifth implementations, the event trigger is the CHO and the event configuration includes a set of time and frequency resources for transmitting the second message to the one or more AIoT devices.

A seventh implementation, alone or in combination with one or more of the first through sixth implementations, process 1000 may include transmitting, to the first network device or the second network device upon completion of the mobility command, an updated status report of the AIoT inventory procedure in a conformation message acknowledging a completion of the mobility command, where the updated status report includes at least one of: a number of the one or more AIOT devices inventoried or a number of the one or more AIoT devices remaining to be inventoried; or a number of access occasions used or a number of access occasions remaining for the one or more AIoT devices prior to the event trigger. In an eighth implementation, alone or in combination with one or more of the first through seventh implementations, the event configuration includes at least one measurement report.

Although FIG. 10 shows example blocks of process 1000, in some implementations, process 1000 may include additional blocks, fewer blocks, different blocks, or differently arranged blocks than those depicted in FIG. 10. Additionally, or alternatively, two or more of the blocks of process 1000 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed in a wireless transmit/receive unit (WTRU), the method comprising:
receiving, from a first network device, an event configuration for reporting a status of an Ambient Internet of Things (AIoT) inventory procedure in one or more AIoT devices and an AIoT inventory request for the one or more AIOT devices;
sending, to the one or more AIoT devices, a first message initiating an AIoT inventory procedure;
detecting an event trigger;
sending, to the first network device, a status report indicating a status of the AIoT inventory procedure currently ongoing in the one or more AIoT devices;
receiving, from the first network device, a mobility command corresponding to the event trigger;
transmitting, to the one or more AIoT devices, a second message indicating an interruption of the AIoT inventory procedure currently ongoing in the one or more AIoT devices;
receiving, from the first or a second network device, an updated AIoT inventory request for the one or more AIOT devices; and
transmitting, to the one or more AIoT devices, a third message containing at least an indication that the AIoT inventory procedure is being continued in the one or more AIoT devices.

2. The method of claim 1, wherein the status report includes at least one of an indication of whether the AIoT inventory procedure is ongoing, and a requested resource timing based on a monitoring cycle of the one or more AIoT devices.

3. The method of claim 1, wherein the event trigger is one of: a radio link failure (RFL), a handover (HO), or a conditional handover (CHO).

4. The method of claim 3, wherein the mobility command includes a resource configuration for transmitting the second message.

5. The method of claim 1, further comprising transmitting, to the first network device or the second network device upon completion of the mobility command, an updated status report of the AIoT inventory procedure in a conformation message acknowledging a completion of the mobility command, wherein the updated status report includes at least one of: a number of the one or more AIoT devices inventoried or a number of the one or more AIoT devices remaining to be inventoried; or a number of access occasions used or a number of access occasions remaining for the one or more AIoT devices prior to the event trigger.

6. The method of claim 2, wherein the updated AIoT inventory request includes an updated resource configuration for transmitting the updated AIOT inventory request to the one of more AIoT devices, the updated resource configuration including at least one of a number of access occasions or a set of time and frequency resources for transmitting the updated AIoT inventory request to the one or more AIoT devices.

7. The method of claim 6, wherein the inventory procedure is resumed in the one or more AIoT devices using the updated resource configuration.

8. The method of claim 3, wherein the event trigger is the CHO and the event configuration includes a set of time and frequency resources for transmitting the second message to the one or more AIoT devices.

9. The method of claim 1, wherein the event configuration includes at least one measurement report.

10. A wireless transmit/receive unit (WTRU) comprising:
processor circuitry; and
a transceiver configured to:
receive, from a first network device, an event configuration for reporting a status of an Ambient Internet of Things (AIoT) inventory procedure in one or more AIoT devices and an AIoT inventory request for the one or more AIOT devices;
send, to the one or more AIoT devices, a first message initiating an AIoT inventory procedure;
the process circuitry configured to detect an event trigger;
the transceiver configured to:
send, to the first network device, a status report indicating a status of the AIoT inventory procedure currently ongoing in the one or more AIoT devices;
receive, from the first network device, a mobility command corresponding to the event trigger;
transmit, to the one or more AIoT devices, a second message indicating an interruption of the AIoT inventory procedure currently ongoing in the one or more AIoT devices;
receive, from the first or a second network device, an updated AIoT inventory request for the one or more AIOT devices; and
transmit, to the one or more AIoT devices, a third message containing at least an indication that the AIoT inventory procedure is being continued in the one or more AIoT devices.

11. The WTRU of claim 10, wherein status report includes at least one of an indication of whether the AIoT inventory procedure is ongoing, and a requested resource timing based on a monitoring cycle of the one or more AIoT devices.

12. The WTRU of claim 10, wherein the event trigger is one of: a radio link failure (RFL), a handover (HO), or a conditional handover (CHO).

13. The WTRU of claim 12, wherein the mobility command includes a resource configuration for transmitting the second message.

14. The WTRU of claim 10, wherein the transceiver is further configured to transmit, to the first network device or the second network device upon completion of the mobility command, an updated status report of the AIoT inventory procedure in a conformation message acknowledging a completion of the mobility command, wherein the updated status report includes at least one of: a number of the one or more AIoT devices inventoried or a number of the one or more AIoT devices remaining to be inventoried; or a number of access occasions used or a number of access occasions remaining for the one or more AIoT devices prior to the event trigger.

15. The WTRU of claim 11, wherein the updated AIoT inventory request includes an updated resource configuration for transmitting the updated AIoT inventory request to the one of more AIoT devices, the updated resource configuration including at least one of a number of access occasions or a set of time and frequency resources for transmitting the updated AIoT inventory request to the one or more AIoT devices.

16. The WTRU of claim 15, wherein the transceiver is further configured to send, to the one or more AIoT devices, the third message using the updated resource configuration.

17. The WTRU of claim 12, wherein the event trigger is the CHO and the event configuration includes a set of time and frequency resources for transmitting the second message to the one or more AIoT devices.

18. The WTRU of claim 10, wherein the received event configuration includes at least one measurement.
